(19) United States
(12) Patent Application Publication
(10) Pub. No.: US 2005/0287863 A1
(43) Pub. Date: Dec. 29, 2005

(54) Insulation piercing contact alignment system

(75) Inventors: Anthony Tufano, North Massapequa, NY (US); David B. Balaban, Haupauge, NY (US); Mehmet K. Tanacan, Farmingdale, NY (US); Denise Chan-Richter, Bethpage, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(73) Assignee: Leviton Manufacturing Co. Inc.

(21) Appl. No.: 11/145,989

(22) Filed: Jun. 7, 2005

Related U.S. Application Data
(60) Provisional application No. 60/579,012, filed on Jun. 14, 2004.

(51) Int. Cl. H01R 4/24

(52) U.S. Cl. 439/418

(57) ABSTRACT

A system and method for the alignment of an insulation piercing contact within a two piece switch housing with an insulated electrical wires disposed within the housing. The housing is comprised of two halves whereby when the two halves are brought together during assembly, the insulation piercing contact pierces the insulation of the electrical wires and forms an electrical connection between the contact and the wires. Proper alignment between the insulation piercing contact and the insulated electrical wires is ensured by providing extended prongs on one half of the switch housing. On the other half of the switch housing, channels are provided and arranged to slidably engage and mate with the prongs prior to contact of the electrical wires with the piercing contact. The prongs and channels fix the relative alignment of the contact with the wire before piercing occurs and ensures consistent location of the electrical connection formed during assembly of the switch housing.

This application claims the benefit of the filing date of a provisional application having Ser. No. 60/579,012 which was filed on Jun. 14, 2004.

### FIELD OF THE INVENTION

The present invention relates to the field of electrical connectors and switches.

### BACKGROUND OF THE INVENTION

Inline feed-thru switches are frequently used in the electrical appliance industry to provide a means of switching an appliance on and off from the electrical cord which powers the appliance. In prior art switches, insulation piercing contacts are used to provide an electrical connection between the switch being installed and insulated electrical wires powering the appliance. Typically, the insulation piercing contacts are disposed such that when the two halves of a housing containing the switch elements and the insulation piercing contacts are mated to each other, the contacts pierce through the insulated wires thereby establishing electrical contact between the switch and the wires.

A drawback of prior art switches, however, is that in some instances maintaining the alignment of the insulation piercing contacts relative to the center of the insulated wires to which the switch is being attached can be difficult. In particular, where the insulation piercing contacts have appreciable height dimensions, it is not uncommon for the insulation piercing contacts to miss the center of the insulated wires to which they are being attached due to movement of the switch housing relative to the wires during assembly of the switch/wire combination. The movement of the switch housing relative to the insulated wires creates a misalignment of the insulation piercing contacts relative to the wires being pierced thereby causing a failure of the insulation piercing contact to make good electrical contact with the wires and thus a failure of the switch/wire assembly.

To correct the misalignment problem it is frequently necessary to stabilize the switch housing during assembly by some external means which is both time consuming and adds additional manufacturing costs to the assembly process. A need therefore exists for a new improved apparatus to maintain the correct alignment of the insulator piercing contacts with the insulated conductors during assembly.

### SUMMARY OF THE INVENTION

The present invention is embodied in a housing for an electrical switch that contains insulation piercing contacts for establishing electrical contact with insulated electrical wires located within the housing. In a preferred embodiment of the invention, the switch housing comprises two halves mated together that contain at least one contact cavity within the housing. The contact cavity has a first face disposed in a first half of the switch housing for snugly receiving at least one insulated wire and a second face disposed in a second half of the housing containing insulation piercing contacts. The second half of the housing also contains a switch mechanism for operating the assembled switch. When the two halves are joined together, the insulation piercing contact forms an electrical connection with the conductor and is also electrically connected to the switch.

The insulation piercing contacts are positioned such that when the two halves of the switch housing are properly aligned and mated, the insulation piercing contacts make electrical contact with the insulated conductors by piercing the center of the insulation of the insulated electrical wires placed in the first half of the switch housing. In order to maintain proper alignment of the two halves of the housing during assembly of the switch/wire combination, the first half of the switch housing includes a plurality of projections that extend from the first half of the switch housing. Correspondingly, the second half of the switch housing includes a plurality of recesses that are formed in the second half of the switch housing and which are arranged to slidably engage and mate with the projections in the first half of the switch housing.

Engagement of the projections in the first half and the recesses in the second half, fixes the relative alignment of the first and second halves of the switch housing. The dimensions of the projections and recesses in the first and second halves of the switch housing respectively are selected such that the projections in the first half and the recesses in the second half of the switch housing engage each other before the insulation piercing contacts in the second half of the switch housing come into contact with the insulation of a wire placed within the housing. In this manner, the correct relative alignment of the insulation piercing contacts with the insulated wires is maintained throughout the switch/wire assembly process thereby ensuring the formation of a good electrical connection between the insulation piercing contacts and the electrical wires disposed within the housing.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an isometric view of a switch according to the present invention

FIG. 2 is a cross-sectional view of a disassembled switch according to the present invention

FIG. 3 is a cross-sectional view of an assembled switch according to the present invention.

### DETAILED DESCRIPTION OF THE PREFERRED EMBODIMENT

Reference will now be made in detail to the preferred embodiments of the present invention, examples of which are illustrated in the accompanying drawings.

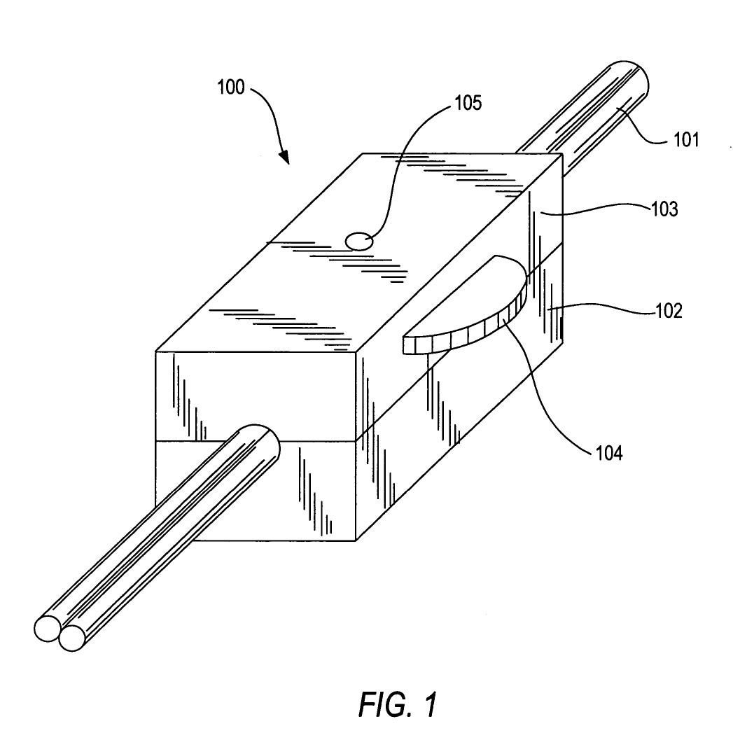

The present invention relates to a method of alignment and apparatus to ensure the correct alignment of insulation piercing electrical contacts with an insulated wire during switch assembly. FIG. 1 depicts a switch according to the present invention. As depicted therein, the present invention is embodied in an in-line feed thru switch assembly comprising a housing 100 adapted for mounting onto insulated wires 101. The housing 100 is comprised of a first half 102 and a second half 103. A rotating actuator 104 is disposed in the second half 103 and operates to switch an appliance to which electrical wires 101 are attached on and off. The two halves 102 and 103 of housing 100 are held together with a captive screw and nut assembly 105.

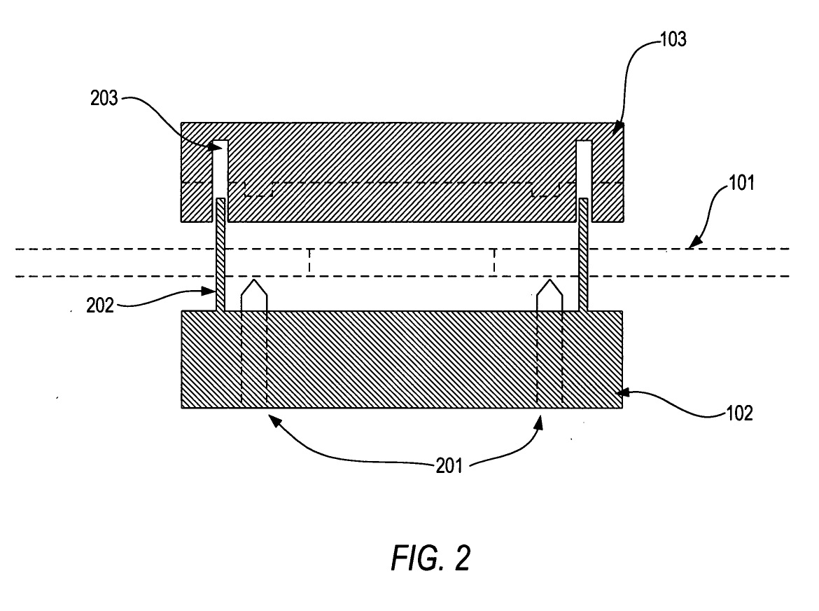

Referring now to FIG. 2, depicted therein is a cross-sectional view of housing assembly 100. As shown in FIG. 2, first half 102 contains an insulation piercing contact 201 that forms an electrical connection with insulated wires 101 when first and second halves 102 and 103 are brought together, thereby causing contact 102 to pierce wires 101. In order to maintain the correct alignment between contact 102 and wires 101 during assembly of housing 100, alignment pins 202 are formed on first half 102.

Correspondingly, alignment channels 203 are provided on second half 103 and are arranged to slidably engage and mate with pins 202 disposed on first half 102 when the two halves 102 and 103 are brought together during assembly of housing 100. The dimensions of pins 202 and channels 203 are selected such that pins 202 and channels 203 slidably engage each other before contact 102 comes into contact with wires 101. Once alignment pins 202 and channels 203 are engaged with each other, the alignment of contact 102 relative to wires 101 becomes fixed and as the two halves are slid together to form housing 100, contact 201 pierces wires 101 and forms an electrical connection. By ensuring that pins 202 and channels 203 engage before contact 201 comes into contact with wires 101 the switch assembly of the present invention ensures that the alignment of contact 201 relative to wires 101 will always be correct and consistently result in good electrical contact between wires 101 and contact 201.

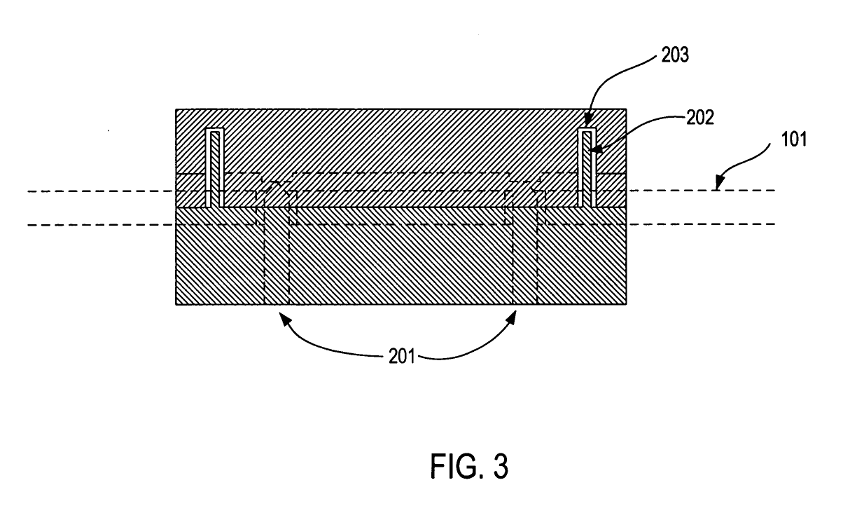

FIG. 3 depicts a cross sectional view of an assembled housing 100 according to the present invention. As is shown in FIG. 3, when pins 202 and channels 203 are fully engaged, the relative alignment of contact 201 and wires 101 stays fixed and contact 201 pierces wires 101 thereby establishing an electrical connection between contact 201 and wires 101. Thus by ensuring that the correct alignment of insulation piercing contact 201 is maintained during housing 100 assembly the present invention provides an integral means of ensuring the alignment of elements of housing 100 during assembly.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1. An in line switch housing comprising:
a first half having at least one cavity for receiving an insulated electrical wire, said first half further comprising prongs;
a second half having channels sized and arranged in correspondence with said prongs and adapted to slidably engage said prongs; and
at least one insulation piercing contact disposed within said second half, said insulation piercing contact adapted to pierce said insulated electrical wire when said first half and second half are brought into contact wherein slidably engaging said prongs with said channels fixedly aligns said contact with said wire before bringing said piercing contact into contact with said wire.

2. A method for maintaining the alignment of an insulated conductor relative to piercing contacts during assembly of an inline switch housing comprising:
placing at least one insulated conductor in one of a first and second half of a housing, said first half of said housing having a first mating surface, said second half of said housing having a second mating surface, said first and second mating surfaces adapted to engage one another when placed in close proximity to one another thereby placing said first and second halves of said housing in fixed alignment with one another, wherein at least one of said first and second halves of said housing comprises at least one of a switch, and at least one insulation piercing contact adapted to pierce said insulated conductor when said first mating surface and said second mating surface are substantially engaged;
positioning said first and second halves of said housing in a first position, said first position comprising initial engagement of said first mating surface with said second mating surface, said initial engagement placing said first half in said fixed alignment with said second half while maintaining separation of said at least one piercing contact from said insulated conductor;
moving said first and said second halves of said housing to a second position, said second position comprising substantial engagement of said first mating surface with said second mating surface wherein said first half and said second half of said housing are in fixed alignment and wherein said movement of said first and second halves from said first position to said second position causes said insulation piercing contact to pierce said insulated conductor thereby establishing an electrical contact.

3. The method according to claim 2 wherein said first mating surface comprises prongs and said second mating surface comprises channels adapted to slidably receive said prongs.

4. The method according to claim 2 wherein said first mating surface comprises tabs and said second surface comprises an interior surface of said second half of said housing.

5. An in line switch housing comprising:
a first half having at least one cavity for receiving an insulated electrical wire, said first half further comprising a first mating surface;
a second half comprising a second mating surface adapted to correspondingly engage said first mating surface; and
at least one insulation piercing contact disposed within at least one of said first and second halves, said insulation piercing contact adapted to pierce said insulated electrical wire when said first half and second half are brought into substantial contact wherein engaging said first mating surface with said second mating surface fixedly aligns said insulation piercing contact with said wire and subsequently brings said piercing contact into contact with said wire thereby piercing said wire and establishing an electrical contact between said wire and said piercing contact.

6. The switch housing according to claim 5 wherein said first mating surface comprises prongs and said second mating surface comprises channels adapted to slidably receive said prongs.

7. The switch housing according to claim 5 wherein said first mating surface comprises tabs and said second surface comprises an interior surface of said second half of said housing.
